(19) United States
(12) Patent Application Publication
(10) Pub. No.: US 2016/0076450 A1
(43) Pub. Date: Mar. 17, 2016

(54) Solar Jet Turbofan Aircraft Engine

(71) Applicant: Bob Burkett, Dallas, TX (US)

(72) Inventor: Bob Burkett, Dallas, TX (US)

(73) Assignee: Bob Burkett, Dallas, TX (US)

(21) Appl. No.: 14/692,553

(22) Filed: Apr. 21, 2015

Related U.S. Application Data
(60) Provisional application No. 61/981,857, filed on Apr. 21, 2014.

(51) Int. Cl. F02C 7/08; F02K 1/32; F02K 1/04; F02C 3/04

(52) U.S. Cl. CPC F02C 7/08; F02C 3/04; F02K 1/32; F02K 1/04; F05D 2220/323; F05D 2260/85

(57) ABSTRACT

The Solar Jet Turbofan Aircraft Engine is a system and method for utilizing electrical heating elements to heat compressed air within a jet engine's “Heating Chamber” in order to increase or decrease thrust.

### CROSS-REFERENCE TO RELATED APPLICATIONS

This application claims the benefit of the filing of U.S. Provisional Patent Application Ser. No. 61/981,857 filed on Apr. 21, 2014 entitled “The Solar Jet Turbofan Aircraft Engine” and the disclosure of which is incorporated herein by reference in its entirety.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

One of the problems that the world faces is how to reduce its usage of fossil fuel due to its inevitable exhaustion, the expense of manipulating it and its effect on the environment. One of the many things that contribute to air pollution and global warming is the exhaust of jet fumes.

A separate invention has incorporated the usage of electrical power within a jet engine (U.S. Pat. No. 8,727,271 B2) however the majority of the time the engine burns fossil fuel. This new embodiment of a jet engine does not require the use of fossil fuel in order to operate thereby reducing the cost of operation and eliminating the emission of harmful gas fumes into the atmosphere.

### BRIEF SUMMARY OF THE INVENTION

The Solar Jet Turbofan Aircraft Engine is a revolutionary process that changes the type of fuel necessary to power a jet engine. The power of the sun is harnessed through solar panels. The solar panels are located on top of the aircraft. This solar power is converted to electricity which is stored in a battery, used to start the compressor fan and/or used to super heat electrical elements within a heating chamber. The primary compressor fan that is started by an electric motor sets into motion a process that creates jet power. This fan spins at a high rpm and sends the air through a stator that guides the flow of the air through the nacelle and the heating chamber that ultimately force the air through the nozzle creating thrust that propels the aircraft.

In a Turbofan design the annular compression fan is larger than the radius of the heating chamber's air input opening. This process makes the fan more economical than a Turbojet design where the compressor fan is the same size as the opening of the heating chamber. The airflow from the fan is compressed due to the resistance of the turbine. Thus there is not an “even flow” of air exiting the turbine.

This compressed air is forced into the “heating chamber” where a high powered electrical element (or series of electrical elements) can super heat the air. This process increases the pressure of the air which increases the speed that the turbine turns and thereby the force of the thrust is increased since the turbine is connected by a shaft to the primary compressor fan.

Traditionally, a jet engine's power is increased by the combustion of oxygen and fossil fuel within the combustion chamber of the jet engine. In this invention the traditional fossil fuel (e.g. Jet A) that is combined with oxygen and lit with an igniter is replaced by an electrical heating element.

The compressed air is forced into a combination of compressor blades (fans) and stator blades which guide the high velocity air towards the turbine. The turbine is connected with a shaft (or a combination of shafts) to the compressor fan which turns the fan in tandem with the turbine. The shaft extends through the compressor fan and turns the generator/alternator which is covered by a nose cone that protects the generator/alternator and also diverts the incoming air.

The electricity that is generated is sent to the electrical heating elements, the battery or other parts of the aircraft as needed via a Master Control Unit. The increase or decrease of this heat within the heating chamber is what controls the speed of the aircraft. Another embodiment of the invention is to add additional compressor blades as needed in order to further compress the air into the heating chamber.

Yet another embodiment of the invention is to add an additional heating chamber which serves as an “afterburner”. The compressed air is sent through the first phase of the heating chamber and then it is reheated again in the “afterburner”. The purpose of the afterburner is to increase the thrust of the aircraft temporarily if needed for take-offs, landings and other vital maneuvers. The afterburner is an alternative embodiment of the jet engine design.

The air exhaust is forced through a nozzle which concentrates the air and creates a powerful force that propels the aircraft forward. A moveable and/or adjustable thrust controller can be incorporated within the nozzle such that it directs the exhaust air thereby guiding the aircraft. This is an optional modification. A thrust reverser is attached to the nozzle that enables the thrust to be utilized to slow or stop the aircraft.

### BRIEF DESCRIPTION OF THE SEVERAL VIEWS OF THE DRAWING

There are four configurations of the design that are viewed.

FIG. 1 is with series of compressor fans and stator blades with an afterburner.

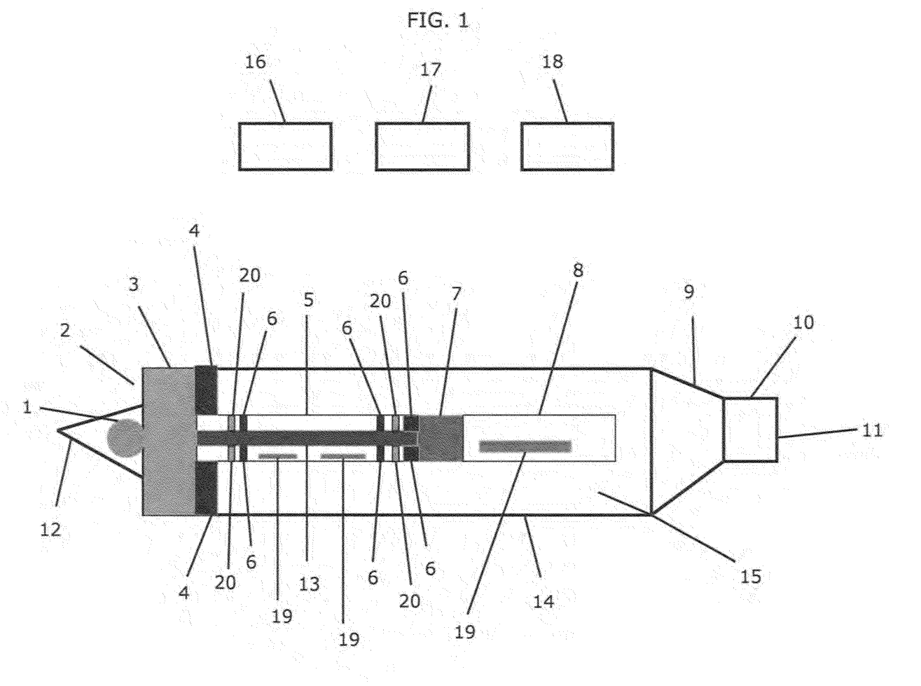

FIG. 2 is with a series of compressor fans and stator blades without an afterburner.

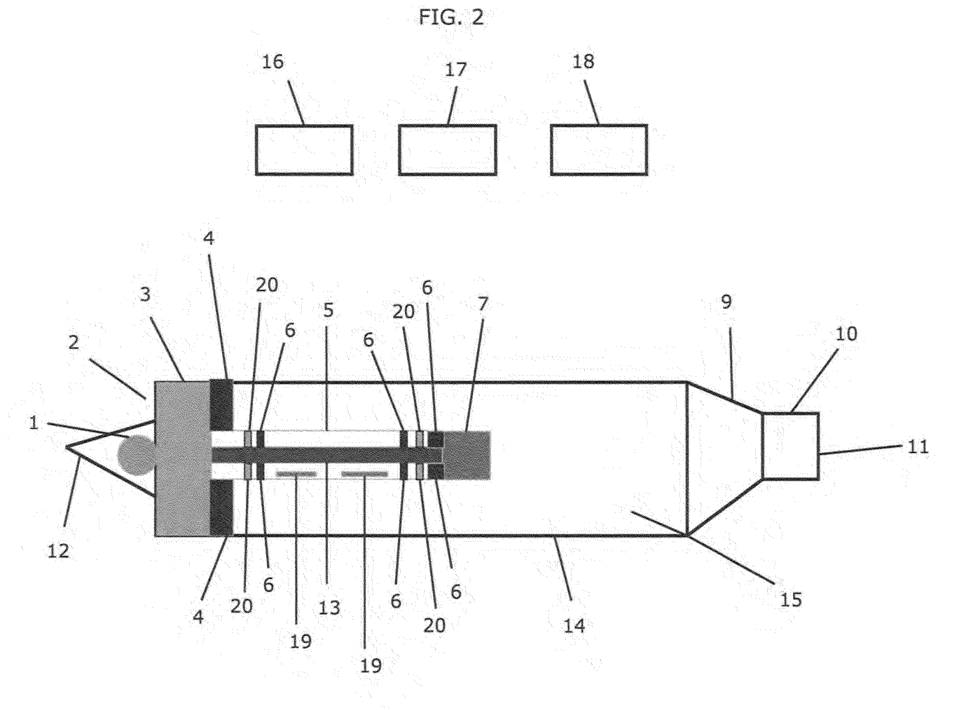

FIG. 3 is with a single compressor fan and with an afterburner.

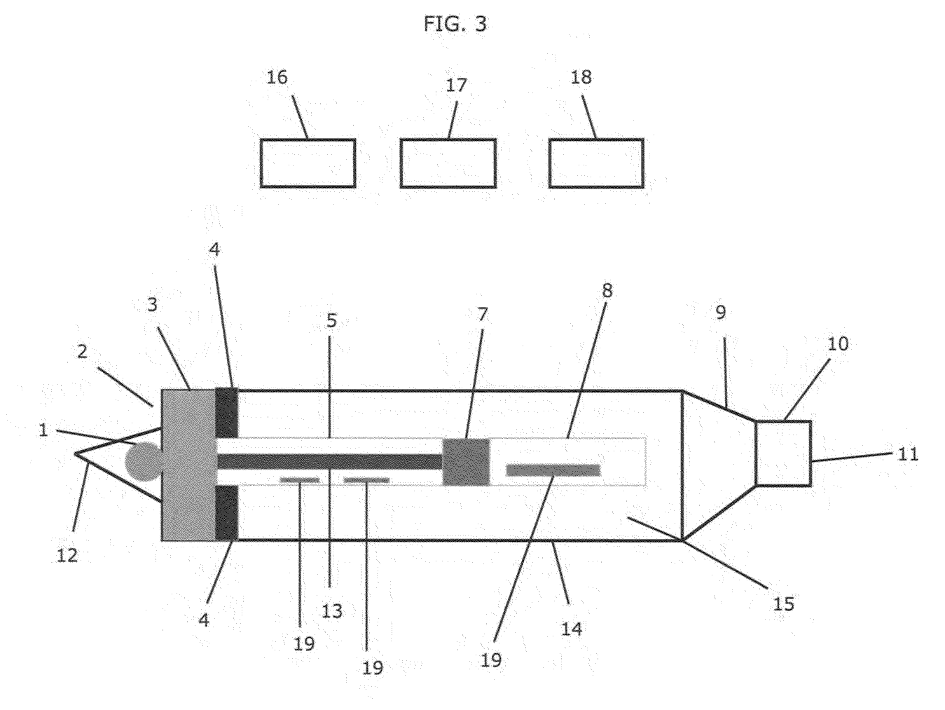

FIG. 4 is with a single compressor fan and without an afterburner.

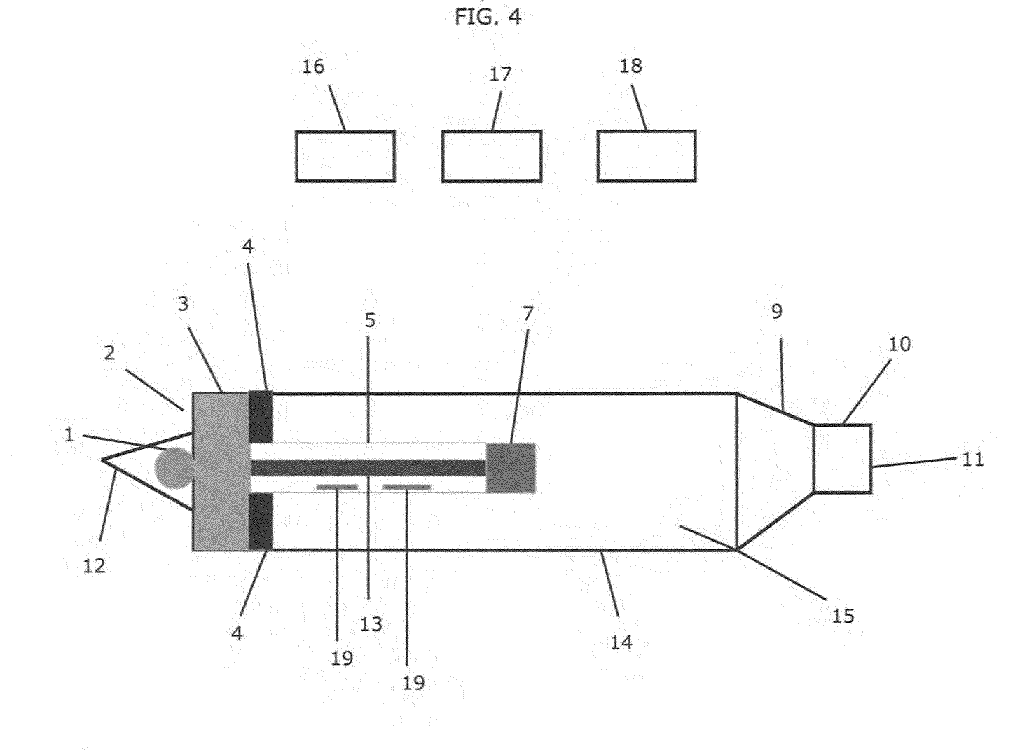

### DETAILED DESCRIPTION OF THE INVENTION

The Solar Panel (16) transforms solar energy into electrical energy. This electricity is then sent to the Master Control Unit (17) where it is directed to the battery (18) to store the energy, the Compressor Fan (3) to start the process, the Electric Heating Elements (19) to super heat the compressed air in the Primary Heating Chamber (5) and/or the Secondary Heating Chamber/Afterburner (8) in order to increase or decrease the speed of the aircraft. It also is directed to other parts of the aircraft as needed (e.g. cockpit).

The Electricity Generator (1) can be an Alternator (Direct Current) and/or a Generator (Alternating Current); its function is to generate electricity via the spinning of the shaft (13) and then send it to the Master Control Unit (17) where a decision is made to route the electricity to the battery (18) and/or the Heating Element (19) and/or other parts of the aircraft. The Air Input (2) is where the air flows into the engine's Nacelle (14). The Nacelle (14) encloses the aircraft engine parts.

The Compressor Fan (3)—forces air into the Air Bypass Chamber (15) and the Primary Heating Chamber (5) and compresses it due to the resistance caused by the Turbine (7) and the heating of the air. This Fan (3) is started electrically with energy from the Solar Panel (16) and/or the Battery (18). The Primary Stator Blade (4) is a stationary device that directs the air into the proper flow towards the Nozzle (9). The Primary Heating Chamber (5) then superheats to further expand the compressed air inside the Heating Chamber (5). Another embodiment of the invention is to add additional compressor blades (20) and stator blades (6) that are attached to the shaft as needed in order to further compress the air into the heating chamber.

The Stator Blade (6) directs the air into the proper flow towards the Turbine (7). The Turbine (7) turns as a result of the compressed super heated air being forced into the heating chamber and exiting through the chamber. This compressed air spins the Turbine (7). The Turbine (7) is connected to a Shaft (13) that turns the Compressor Fan (3). The shaft (13) extends through the Compressor Fan (3) and turns a generator and/or alternator (1). The shaft can be comprised of low pressure and high pressure spools.

The Secondary Heating Chamber or “Afterburner” (8) reheats the exhaust air causing it to expand further as it is forced out the back of the Nacelle (14) through the Nozzle (9) creating additional thrust. The Thrust Reversal Unit (10) is a moveable device connected to end of the Nozzle (9) in order to redirect the thrust forward in order to slow the vehicle. The Nozzle (9) can be adjustable and maneuverable to any angle in order to guide the aircraft as necessary. The Nozzle (9) is mandatory while the adjustability and maneuverability aspect of the Nozzle (9) is optional.

The Air Exhaust (11) is the compressed heated air combined with the cooler air generated by the primary Compressor Fan (3) that bypasses the heating chamber and is forced out the back of the Nacelle (14) through the Nozzle (9) creating the thrust and force that propels the aircraft. The Nozzle (9) concentrates the thrust of the exhaust air flow. The Thrust Reversal Unit (10) deflects the exiting exhaust air forward in order to slow the speed of the aircraft when necessary.

The Nose Cone (12) is a pointed cone that deflects incoming air and protects the Electrical Generator/Alternator (1) from excessive air pressure from incoming air at high speeds.

The Stator Blades (4, 6) direct the air into the proper flow towards the Turbine (7) and the Nozzle (9). The Shaft (13) connects to the Turbine (7), the Compressor Fan (3) and the Generator and/or Alternator (1). The Air Bypass Chamber (15) sends excess air from the Compressor Fan (3) through the chamber that surrounds the Heating Chambers (5 and 8). It has a larger diameter than the Heating Chamber (5) and creates the majority of the thrust. It also cools the outside of the Heating Chambers (5 and 8). The Air Bypass Chamber (15) sends excess air from the Compressor Fan (3) through this chamber that surrounds the Primary Heating Chamber (5) and the Secondary Heating Chamber (8) where the air merges with the heated compressed air and is forced through the nozzle creating thrust that propels the aircraft forward.

### LIST OF REFERENCE NUMERALS

1. Electricity Generator
2. Air Input
3. Compressor Fan (Electric Starter)
4. Stator (stationary) Blade
5. Primary Heating Chamber
6. Stator (stationary) Blade
7. Turbine
8. Secondary Heating Chamber (Afterburner)
9. Nozzle
10. Thrust Reversal Unit
11. Air Exhaust
12. Nose Cone
13. Shaft
14. Nacelle
15. Air Bypass Chamber
16. Solar Panel
17. Master Control Unit
18. Battery
19. Electric Heating Element
20. Compressor Blades

1. A system for generating jet engine power, said system comprising:
an electricity generator that creates electricity;
an electric compressor fan that forces air into the nacelle;
a series of stator (stationary) blades that direct the air;
a primary heating chamber;
a secondary heating chamber or “afterburner” (optional);
a turbine;
a nozzle;
a thrust reversal unit;
air exhaust;
a nose cone that diverts incoming air;
a shaft connected to the turbine, the compressor fan, the compressor blades and the electricity generator;
a nacelle that encloses the engine parts;
an air bypass chamber;
a solar panel;
a master control unit;
a battery;
electric heating elements that super heat the air;
whereby, when the compressor fans force air into the nacelles air bypass chamber and the heating chamber; an electric heating element super heats the compressed air; resulting in a faster turning of a turbine that increases the speed of a shaft connected to the primary fan that propels additional air being forced through the nozzle creating greater thrust for the aircraft.

2. The system of claim 1 wherein an alternative embodiment can utilize an after burner to increase overall power of the engine.

3. The system of claim 1 wherein the invention utilizes electrical heating elements to increase heat and therefore increase pressure inside the “Heating Chamber” resulting in increased thrust.
